(19) United States
(12) Patent Application Publication
(10) Pub. No.: US 2008/0100455 A1
(43) Pub. Date: May 1, 2008

(54) ID TAGS AND METHODS OF USING THE SAME

(76) Inventors: Steven C. Erickson, Rochester, MN (US); Ivory W. Knipfer, Rochester, MN (US); Jeffrey G. Komatsu, Kasson, MN (US); Fraser A. Syme, Rochester, MN (US); William R. Taylor, Rochester, MN (US); Manivannan Thavasi, Rochester, MN (US)

Correspondence Address: IBM Corporation;Intellectual Property Law, Dept. 917, 3605 Hwy. 52 North, Rochester, MN, 55901, US

(21) Appl. No.: 11/554,307

(22) Filed: Oct. 30, 2006

(51) Int. Cl. G08B 13/14

(52) U.S. Cl. 340/572.8

(57) ABSTRACT

In a first aspect, a first apparatus is provided. The first apparatus is an identification device (ID) tag that includes (1) a semiconductor chip; (2) an antenna coupled to the semiconductor chip; (3) a layer of material, coupled to the semiconductor chip, and adapted to provide a persistent visual or audible signal that is observable by a human being; and (4) a controller coupled to the layer of material and adapted to cause the material to provide the signal. Numerous other aspects are provided.

### FIELD OF THE INVENTION

The present invention relates generally to identification devices (IDs), and more particularly to ID tags and methods of using the same.

### BACKGROUND

Identifying parts which do not meet quality requirements is important in product manufacturing environments. In some conventional manufacturing environments, products may be located (e.g., in a warehouse) and physically marked to indicate quality level. For example, parts which do not meet the quality requirements may be located and marked with a “BAD” sticker. For a large number of parts, such a method may require a large number of personnel to be performed efficiently. Consequently, such a method may not be cost-effective.

In some other product manufacturing environments, a conventional radio frequency identification (RFID) tag may be affixed to each defective part. Whether a part meets quality requirements is based on data stored in an RFID tag coupled the part. However, the data stored by traditional RFID tags may not easily be ascertained. For example, an RFID tag scanner/reader must be placed proximate the RFID tag affixed to each part to determine whether the part meets the quality requirements. Therefore, in such conventional product manufacturing environments, each part (typically must) be individually handled to identify whether the part meets quality requirements. Further, for a large number of parts, a large number of RFID tag scanners/readers and/or personnel may be required. Consequently, use of conventional RFID tags is neither efficient nor cost-effective. Accordingly, improved ID tags and methods of using the same are desired.

### SUMMARY OF THE INVENTION

In a first aspect of the invention, a first apparatus is provided. The first apparatus is an identification device (ID) tag that includes (1) a semiconductor chip; (2) an antenna coupled to the semiconductor chip; (3) a layer of material, coupled to the semiconductor chip, and adapted to provide a persistent visual or audible signal that is observable by a human being; and (4) a controller coupled to the layer of material and adapted to cause the material to provide the signal.

In a second aspect of the invention, a first system is provided. The first system is a product manufacturing environment that includes (1) a plurality of parts for one or more products; (2) identification device (ID) tags coupled to the plurality of parts, respectively, wherein each improved ID tag includes (a) a semiconductor chip; (b) an antenna coupled to the semiconductor chip; (c) a layer of material, coupled to the semiconductor chip, and adapted to provide a persistent visual or audible signal that is observable by a human being; and (d) a controller coupled to the layer of material and adapted to cause the material to provide the signal.

In a third aspect of the invention, a first method of identifying a subset of parts in a plurality of parts is provided. The first method includes the steps of (1) providing a plurality of parts; (2) coupling identification device (ID) tags to the plurality of parts, respectively, wherein each ID tag includes (a) a semiconductor chip; (b) an antenna coupled to the semiconductor chip; (c) a layer of material, coupled to the semiconductor chip, and adapted to provide a persistent visual or audible signal that is observable by a human being; and (d) a controller coupled to the layer of material and adapted to cause the material to provide the signal; and (3) employing the ID tags to identify the subset of the plurality of parts. Numerous other aspects are provided, as are systems and apparatus in accordance with these other aspects of the invention.

Other features and aspects of the present invention will become more fully apparent from the following detailed description, the appended claims and the accompanying drawings.

### BRIEF DESCRIPTION OF THE DRAWINGS

FIG. 1 is an exploded isometric view of an identification device (ID) tag in accordance with an embodiment of the present invention.

FIG. 2 is a top view of the ID tag of FIG. 1 communicating with an ID tag scanner/reader in accordance with an embodiment of the present invention.

FIG. 3 illustrates the ID tag of FIG. 1 coupled to a product part in accordance with an embodiment of the present invention.

FIG. 4 illustrates the ID tag of FIG. 1 coupled to a box of product parts in accordance with an embodiment of the present invention.

FIG. 5 illustrates the ID tag of FIG. 1 storing data of a first state in accordance with an embodiment of the present invention.

FIG. 6 illustrates the ID tag of FIG. 5 coupled to a part and a signal provided by the ID tag in accordance with an embodiment of the present invention.

FIG. 7 illustrates the ID tag of FIG. 1 storing data of a second state in accordance with an embodiment of the present invention.

FIG. 8 illustrates the ID tag of FIG. 7 coupled to a part and a signal provided by the ID tag in accordance with an embodiment of the present invention.

FIG. 9 illustrates a method of identifying a subset of parts from a plurality of parts in accordance with an embodiment of the present invention.

FIG. 10 illustrates a step of the method of FIG. 9 in which states of one or more ID tags are set in accordance with an embodiment of the present invention.

FIG. 11 illustrates a step in the method of FIG. 9 in which parts in the subset are contained in accordance with an embodiment of the present invention.

FIG. 12 illustrates the method of FIG. 9 performed on a plurality of parts stored in a flow rack in accordance with an embodiment of the present invention.

### DETAILED DESCRIPTION

The present invention provides an improved ID tag (e.g., label) and methods of manufacturing and using the same. The improved ID tag may be adapted to couple to a part (e.g., a field replaceable unit (FRU)) and employ an indicator that provides a persistent clear visual or audible signal whether the part meets quality requirements. Such signal may be observable by a human being. For example, a portion of the improved ID tag may serve as the persistent clear visual or audible indicator. In some embodiments, the color to which the indicator is set may be based on the quality of the part. For example, if the part does not meet quality requirements, the indicator color may be set to and remain a first color, such as red. Alternatively, if the part meets quality requirements, the indicator may be set to and/or remain another color, such as green.

The improved ID tags may be coupled to respective parts in a product manufacturing environment. Indicators may be set on a plurality of such improved ID tags at the same time using a single ID tag scanner/reader. Therefore, a reduced amount of ID tag scanners/readers and/or personnel may be required to set such indicators. Because the indicators are persistent clear visual or audible signals that are observable by human beings, once the indicators are set, personnel may quickly identify parts which do not meet quality requirements without using an ID tag scanner/reader. Therefore, in such product manufacturing environment, parts which do not meet quality requirements may be contained using a reduced amount of personnel and/or equipment compared to conventional product manufacturing equipment.

An improved ID tag provided in accordance with the present invention may be similar to a traditional ID tag. However, in contrast, the improved ID tag may include a layer of electrochromic polymer material that serves as the indicator. Further, the improved ID tag may include a controller adapted to cause the indicator to be set. For example, the controller may apply a first voltage across the electrochromic polymer material to set the indicator to the first color. Alternatively, the controller may apply a different voltage across the electrochromic polymer material to set the indicator to another color. In this manner, the present invention provides improved ID tags and methods of using the same.

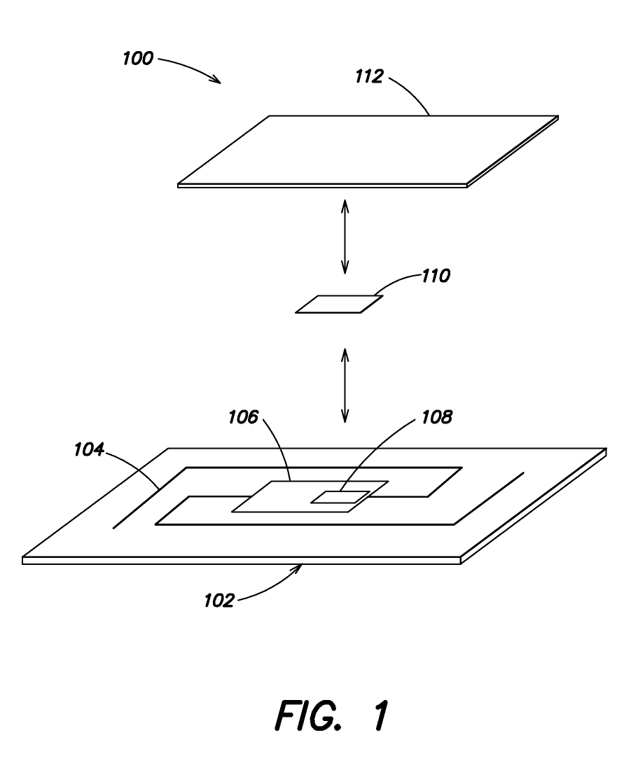

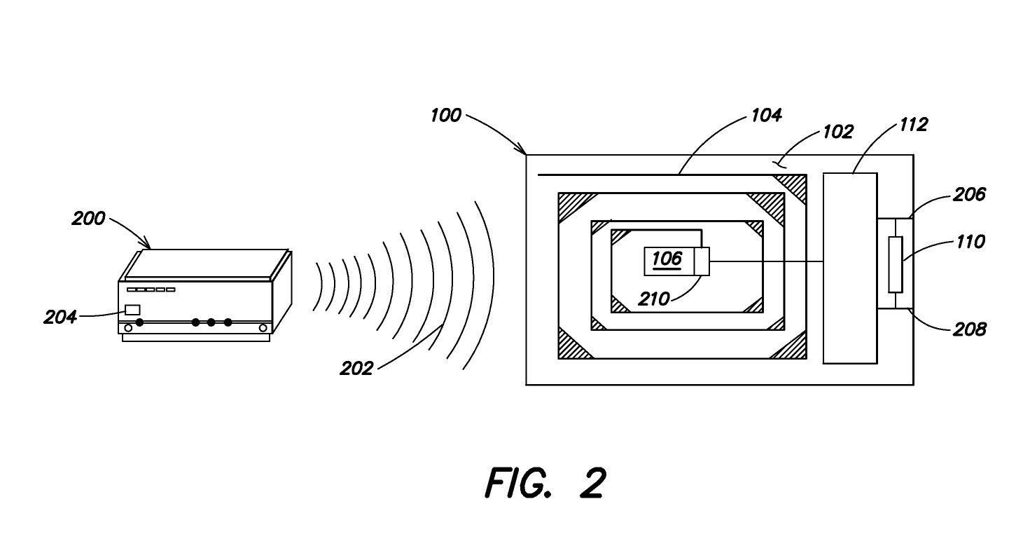

FIG. 1 is an exploded isometric view of an identification device (ID) tag 100 in accordance with an embodiment of the present invention. With reference to FIG. 1, the ID tag 100 may include packaging material 102, such as a nonconductive packaging material, to which an antenna 104 and a semiconductor chip 106 are coupled. The antenna 104 and semiconductor chip 106 may be adapted to communicate with an ID tag scanner/reader (not shown in FIG. 1; 200 in FIG. 2). For example, the antenna 104 may receive signals from a beam of an ID tag scanner/reader 200 and transmit signals to the ID tag scanner/reader 200. In some embodiments, the ID tag 100 and ID tag scanner/reader 200 may communicate using radio waves, shortwaves, high frequencies, ultra high frequencies, microwaves, wireless fidelity, or any other communication protocol. However, the ID tag 100 and ID tag scanner/reader 200 may communicate in a different manner (e.g., using different frequencies).

Further, the semiconductor chip 106 may be adapted to store data, such as data describing a part to which the ID tag 100 is coupled. In contrast to conventional RFID tags, the ID tag 100 may be adapted to store one or more bits 108 indicating whether a part to which the ID tag 100 is coupled is included in a subset of parts. For example, the ID tag 100 may store a bit 108 indicating whether a part to which the ID tag 100 is coupled meets a quality requirement (e.g., a predetermined quality level).

Further, the tag 100 may include a controller 110 and a layer of material 112 coupled to the packaging material 102 and electrically coupled to the semiconductor chip 106. The layer of material 112 have properties that enhance the perceptibility of the packaging material 102. More specifically, the material 112 may be adapted to provide a persistent visual or audible signal that is observable by a human being based on an applied voltage. The controller 110 may be a low-voltage microcontroller that supports basic instruction capabilities (although a different type of controller may be employed). The controller 110 may be adapted to cause the material layer 112 to provide the perceptible signal. For example, the controller 110 may be adapted to cause the layer of material 112 to provide a first signal by applying a first voltage thereto, and to cause the layer of material 112 to provide different signals by applying different respective voltages thereto.

In some embodiments, the material 112 may be an electrochromic polymer or another material which changes color based on a voltage applied thereto. For example, the layer of material 112 may turn a first color, such as red, when a first voltage is applied thereto by the controller 110, and may turn a second color, such as green, when a second voltage is applied thereto by the controller 110. However, the layer of material 112 may turn additional colors in response to additional respective voltages applied thereto by the controller 110.

The controller 110 may be a microcontroller or another suitable device adapted to control the ID tag 100 (e.g., by receiving a signal from components of the ID tag 100, and controlling the ID tag 100 by sending signals to different components of the ID tag 100). In some embodiments, the controller 110 may be a single chip computer (although a larger number of chips may be employed). In this manner, the controller 110 may include functional components, such as a central processing unit, random access memory, read only memory, input/output units, port, timers and/or the like on a single integrated circuit. In some embodiments, the controller 110 may consume low power (e.g., about 50 mW). However, the controller 110 may consume a larger or smaller amount of power. In some embodiments, the controller 110 may be a microprocessor or controller.

FIG. 2 is a top view of the ID tag 100 of FIG. 1 communicating with an ID tag scanner/reader 200 in accordance with an embodiment of the present invention. With reference to FIG. 2, the ID tag scanner/reader 200 may be adapted to employ a beam 202 to transmit data to and/or receive data from the ID tag 100. For example, the antenna 104 of the ID tag 100 may receive power from the scanner/reader beam 202 such that ID tag 100 (e.g., controller 110 included therein) has full function. Further, the ID scanner/reader beam 202 may receive commands from the ID scanner/reader 200. For example, the ID scanner/reader 200 may issue a set/unset command instructing the ID tag 100 to change the state of the perceptible signal of the ID tag 100. The back-end of the ID scanner/reader infrastructure may include logic 204 to determine when the ID tag signal should be set/unset and issue the set/unset command to the ID tag 100 accordingly. In such an embodiment, the controller 110 may be adapted to receive the set/unset command from the ID scanner/reader 200 and merely cause the state of the perceptible signal of the ID tag 100 to be set/unset based on the command. However, in some embodiments, the controller 110 may be adapted to process simple conditional commands. More specifically, the controller 110 may test for a condition and determine whether to set/unset the state of the perceptible signal based thereon. For example, the controller 110 may set/unset the perceptible signal based on current data stored by the ID tag 100 (e.g., “set if tag contains ‘lot=20060228’”). In some embodiments, the controller 110 may be a low-voltage small instruction CPU adapted to perform simple commands related to data stored by the semiconductor chip 106.

To set the state of the perceptible signal, the controller 110 may apply a first voltage across the layer of material 112. For example, the controller 110 may apply a voltage of about 0.02 to about 0.5 V to each of first and second output pins 206, 208 thereof which are coupled to the layer of material 112. However, a larger or smaller and/or different voltage range may be employed. In response to the applied voltage, the perceptible signal provided by the ID tag 100 may be set to a first state. The first state may be an “IDENTIFY” or “ACTIVATE” state. For example, the layer of material 112 may turn red, which easily identifies the part to which the ID tag 100 is coupled as being a member of a subset of the parts being manufactured (e.g., as being a part that does not meet predetermined quality requirements).

The beam 202 provides power to the ID tag 100. Therefore, when the ID scanner/reader 200 stops transmitting the beam 202 to the ID tag 100, the ID tag 100 loses power. However, in some embodiments, the layer of material 112 will retain its state (e.g., remain red). Therefore, the signal is persistent because the signal may be maintained without power.

Once a perceptible signal provided by an ID tag 100 is set to a first state, such signal may be reset by applying a second voltage across the layer of material 112. For example, a voltage of about 0.02 to about 0.5 V may be applied to only one of the first and second pins 206, 208. However, a larger or smaller and/or different voltage range may be employed. In response to the applied voltage, the perceptible signal provided by the ID tag 100 may be set to a second state. The second state may be a “RESET” state. For example, the layer of material 112 may resume its original color, or alternatively, may turn a second color, such as green. The second state will easily identify the part to which the ID tag 100 is coupled as not being a member of a subset of the parts being manufactured (e.g., as being a part which meets predetermined quality requirements)

In this manner, the output pins 206, 208 of the controller 110 may serve to activate the electrochromic material 112 which enhances the packing material 102 of the ID tag 100 such that the ID tag 100 provides a perceptible signal of the first state. Similarly, one or more of the output pins 206, 208 may serve to reset the electrochromic material 112 such that the ID tag 100 provides a perceptible signal of the second state. The semiconductor chip 106 may be coupled to the layer of material 112 and be adapted to store one or more bits 210 of data, which indicates whether the part to which the ID tag 100 is coupled is included in the subset of parts, based on the state of the layer of material 112. For example, in some embodiments, the subset may be parts which do not meet quality requirements, and therefore, the one or more bits 210 may serve as quality indicator bits.

In some embodiments, the ID tag 100 may include a top cover. Additionally or alternatively, a bottom of the ID tag 100 may include an adhesive. Such adhesive may enable the ID tag 100 to couple (e.g., attach) to a part or packaging thereof. Further, the ID tag 100 may be adapted to couple to parts and/or packaging of any size.

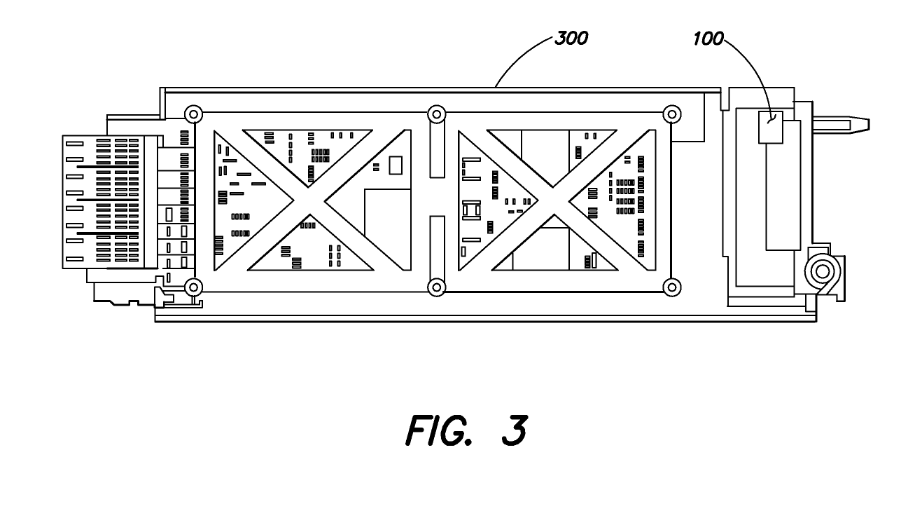

FIG. 3 illustrates the ID tag 100 of FIG. 1 coupled to a product part 300 in accordance with an embodiment of the present invention. With reference to FIG. 3, the ID tag 100 is coupled directly to the part 300. Alternatively, the ID tag 100 may be coupled directly to the part packaging. The part 300 is a network interface card. However, the ID tag 100 may be coupled to a larger, smaller and/or different part (e.g., a widget).

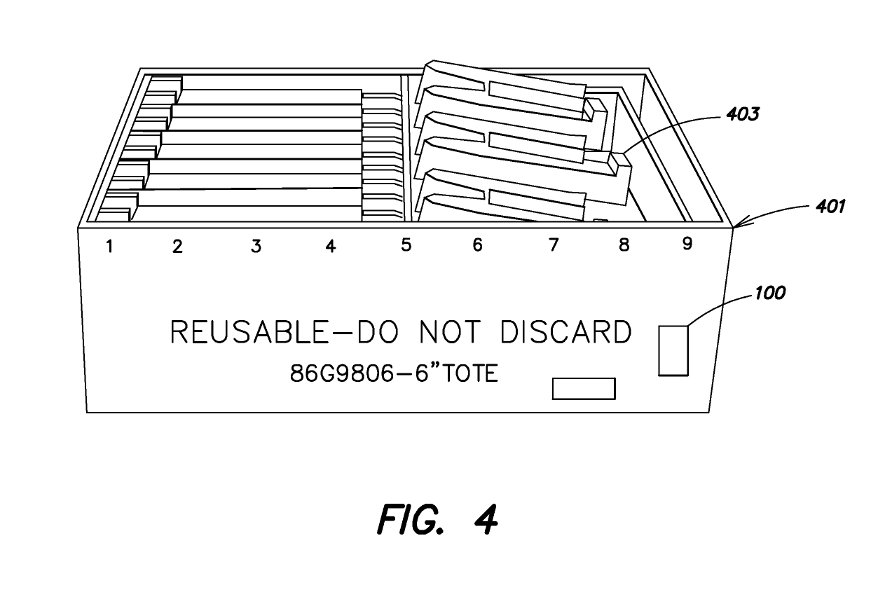

Alternatively, the ID tag 100 may be employed to identify a plurality of parts. For example, FIG. 4 illustrates the ID tag 100 of FIG. 1 coupled to a box 401 of product parts 403 in accordance with an embodiment of the present invention. With reference to FIG. 4, the box 401 is employed to store parts 403 included in a subset of parts (e.g., parts which do not meet predetermined quality requirements (bad parts)). Alternatively, the box 401 may be employed to store parts 403 which are not included in the subset (e.g., parts which meet predetermined quality requirements (good parts)).

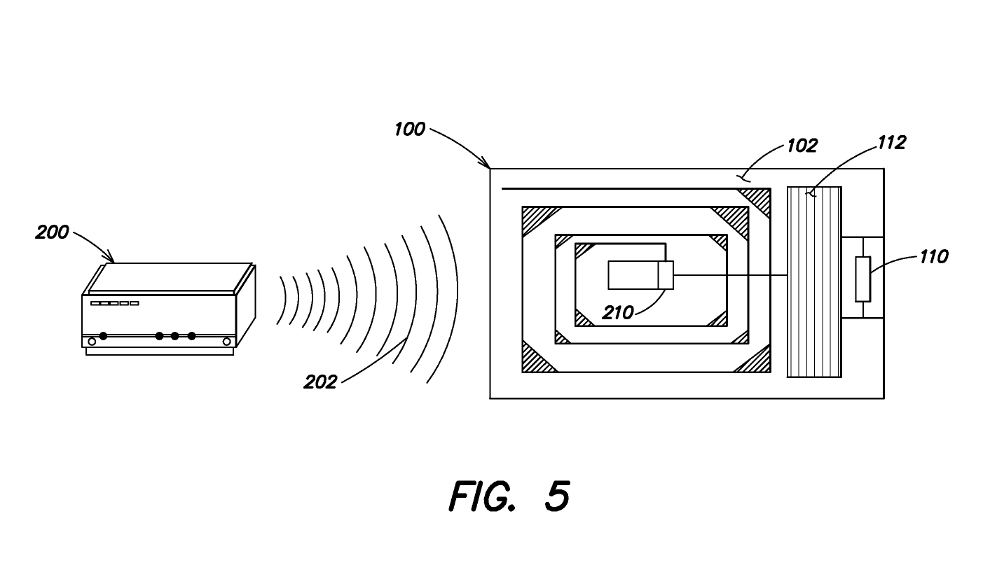

FIG. 5 illustrates the ID tag 100 of FIG. 1 storing data of a first state in accordance with an embodiment of the present invention. With reference to FIG. 5, the ID tag scanner/reader beam 202 issues a command to and powers the ID tag 100 such that the ID tag 100 and controller 110 included therein may have full function. The command may cause the ID tag 100 to signal that a part attached thereto is in the subset. For example, the command may simply instruct the ID tag 100 to perform a set function. The set function may cause the ID tag 100 to signal that the part coupled thereto is included in the subset. The command may be transmitted to the ID tag 100 via the beam 202. In some embodiments, the command may instruct the ID tag 100 to perform a conditional function. For example, the command may instruct the ID tag 100 to perform the set function based on current data stored by the ID tag 100. If the controller 110 determines the ID tag 100 requires a state change, the set function may be performed. For example, the controller 110 may output a small voltage on the two pins 206, 208 connected to the electrochromic polymer enhanced packaging material 102, 112. In response, one or more portions of the packaging material 102, 112 changes color (e.g., turns RED) thereby identifying the requested part. When the beam 202 is removed, the material 102, 112 is adapted to hold its last known state, in this case “IDENTIFY”.

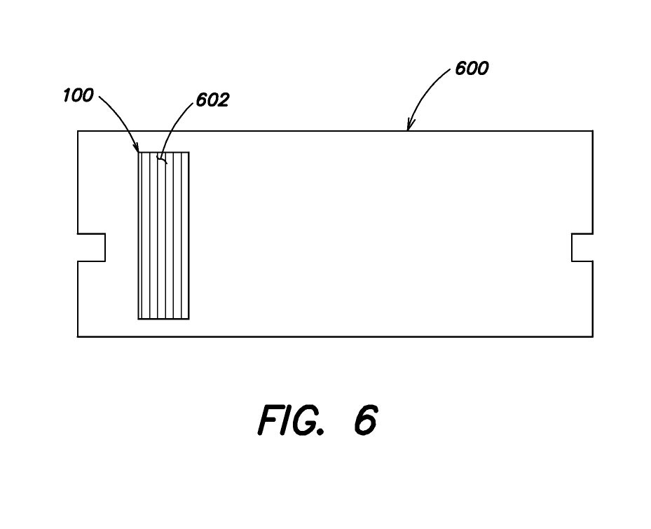

The command may cause the ID tag 100 to perform the set function and thereby cause the material 112 and/or packaging material 102 to turn a first color, such as red. The ID tag signal is persistent and easily observable by a human being. For example, the ID tag 100 may retain its changed color after the ID scanner/reader 200 stops transmitting the beam 202. Further, such color change may be easily detected (e.g., from a distance without use of equipment, such as an ID tag scanner/reader 200). FIG. 6 illustrates the ID tag 100 of FIG. 5 coupled to a part 600 and a signal provided by the ID tag 100 in accordance with an embodiment of the present invention. With reference to FIG. 6, the color (e.g., red) 602 of the ID tag material 112 and possibly the packaging material 112 indicates the part 602 (e.g., a dual in-line memory module (DIMM)) to which the ID tag 100 is coupled is included in the subset of parts. In this manner, such part 602 may be easily identified as bad.

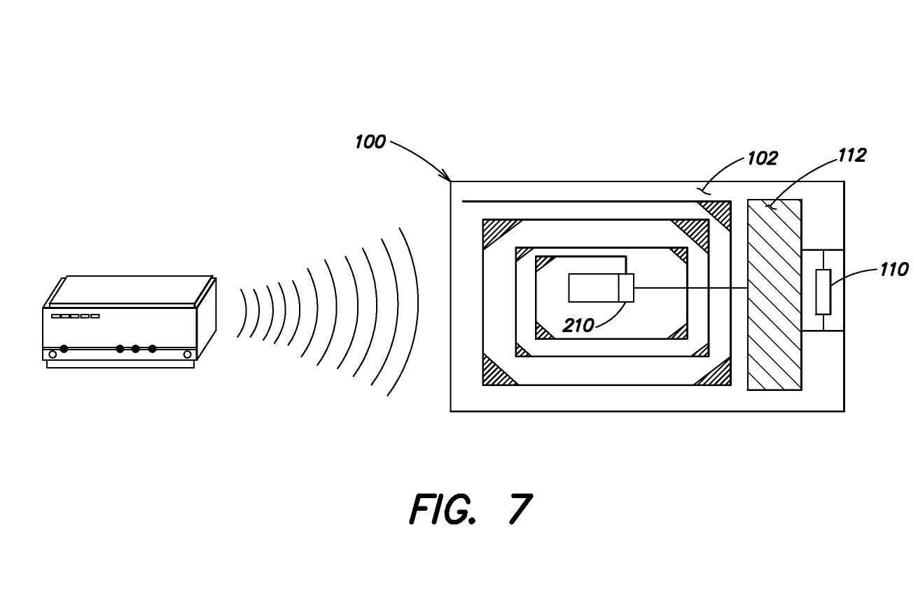

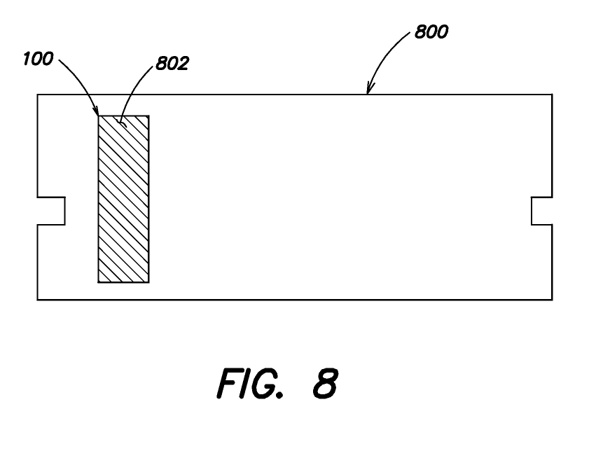

Alternatively, FIG. 7 illustrates the ID tag 100 of FIG. 1 storing data of a second state in accordance with an embodiment of the present invention. With reference to FIG. 7, the ID tag scanner/reader 200 issues a command to and powers the ID tag 100. The command may simply instruct the ID tag 100 to perform an unset function. The unset function may cause the ID tag 100 to signal that the part coupled thereto is not included in the subset. For example, the unset function may cause the material 112 and/or packaging material 102 to turn a second color, such as green. Alternatively, in some embodiments, the unset function may cause the ID tag 100 to return to its original color. Further, in some embodiments, the ID tag 100 may store one or more bits 210 indicating whether the part to which the ID tag 100 is coupled is in the subset (e.g., a quality indicator bits). For example, the quality indicator bit 210 may be asserted when the part is included in the subset (although the quality indicator bit 210 may be asserted when the part is not included in the subset). FIG. 8 illustrates the ID tag 100 of FIG. 7 coupled to a part 800 and a signal provided by the ID tag 100 in accordance with an embodiment of the present invention. With reference to FIG. 8, the color (e.g., green) 802 of the ID tag material 112 and possibly the packaging material 102 indicates the part 802 to which the ID tag 100 is coupled is not included in the subset of parts. In this manner, such part 802 may be easily identified as good.

As stated, the ID tag scanner/reader beam 202 may issue a command to and power the ID tag 100 such that the ID tag 100 and controller 110 included therein may have full function. The command may cause the ID tag 100 to signal that a part attached thereto is not in the subset. For example, the command may simply instruct the ID tag 100 to perform an unset function. The unset function may cause the ID tag 100 to signal that the part coupled thereto is not included in the subset. The command may be transmitted to the ID tag 100 via the beam 202. In some embodiments, the command may instruct the ID tag 100 to perform a conditional function. For example, the command may instruct the ID tag 100 to perform the unset function based on current data stored by the ID tag 100. If the controller 110 determines the ID tag 100 requires a state change, the unset function may be performed. For example, the controller 110 may output a small voltage on one of the two pins 206, 208 connected to the electrochromic polymer enhanced packaging material 102, 112. In response, one or more portions of the packaging material 102, 112 changes color (e.g., turns from red to green) thereby excluding the part from the subset. When the beam 202 is removed, the material 102, 112 is adapted to hold its last known state, in this case “RESET”.

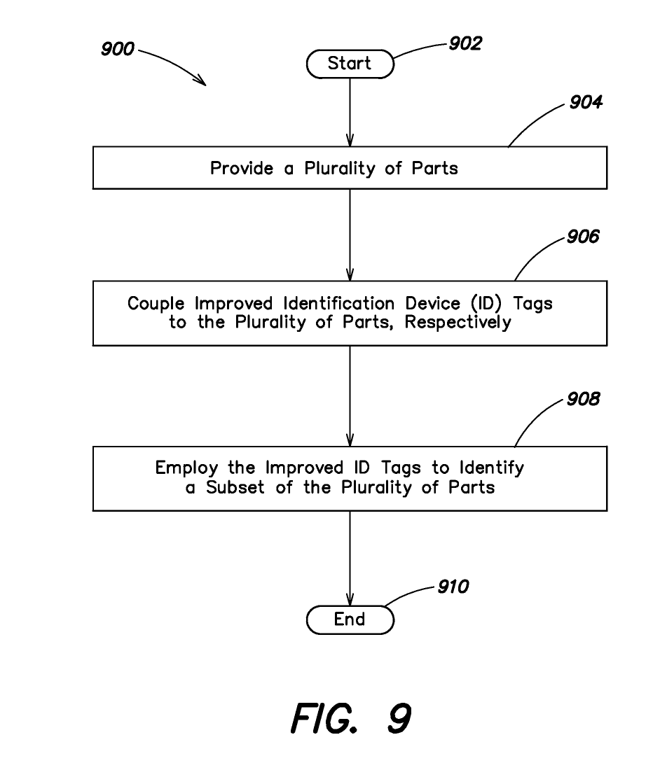

The improved ID tags 100 may be employed to improve product manufacturing. Such improved product manufacturing is described below with reference to FIGS. 9-11. FIG. 9 illustrates a method of identifying a subset of parts from a plurality of parts in accordance with an embodiment of the present invention. With reference to FIG. 9, in step 902, the method 900 begins. In step 904, a plurality of parts may be provided. The parts may be in various stages of a product manufacturing environment. The parts may be automobile brakes, printed circuit boards or any other component of a manufactured product.

In step 906, improved identification device (ID) tags 100 may be coupled to the plurality of parts, respectively. In some embodiments, each improved ID tag 100 includes a semiconductor chip 106, an antenna 104 coupled to the semiconductor chip 106, a layer of material 112, coupled to the semiconductor chip 106. As described above, each ID tag 100 is adapted to provide a persistent visual or audible signal that is observable by a human being. For example, the controller 110 may be coupled to the layer of material 112 and adapted to cause the material 112 to provide the signal. An ID tag 100 coupled to a product may store data describing the product. For example, the ID tag 100 may store a part number, lot number stock keeping unit (SKU) number and/or similar data for the part.

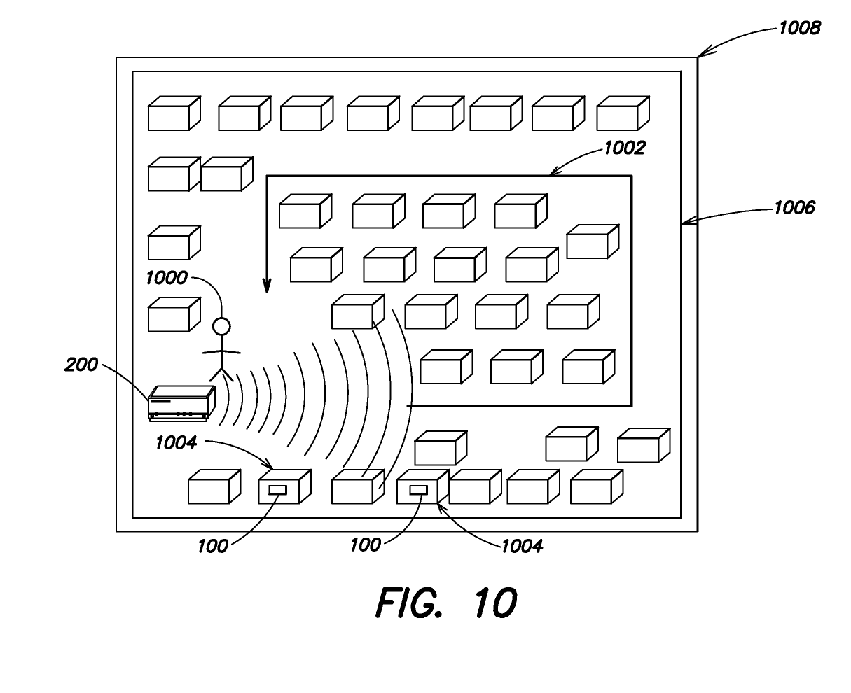

In step 908, the improved ID tags 100 may be employed to identify a subset of the plurality of parts. For example, one or more users may employ respective ID tag scanner/readers 200 to cause ID tags 100 coupled to products to be set to appropriate states, and thereby provide appropriate perceptible signals. FIG. 10 illustrates such a step of the method of FIG. 9 in which states of one or more ID tags 100 are set in accordance with an embodiment of the present invention. With reference to FIG. 10, each user 1000 (only one shown) may employ an ID tag scanner/reader 200 to set the state of one or more ID tags 100 at nearly the same time from a distance (e.g., sweep set). For example, the user 1000 may walk (as shown by the arrow 1002) around parts 1004 in a warehouse 1006 of the product manufacturing environment 1008 to set ID tags 100 coupled to all defective parts 1004 to a first state, (e.g., to cause the ID tags 100 to turn red). In this manner, a user 1000 is not required to handle each part 1004 in a product manufacturing environment 1008 to set respective states of ID tags 100 coupled thereto. Therefore, the one or more users 1000 may efficiently set states of a plurality of parts 1004 in the product manufacturing environment 1008. More specifically, because each part 1004 does not have to be individually handled to set the states on the ID tag 100 coupled to the part 1004, a reduced amount of equipment 200 and/or people may be employed to set ID tag states.

For example, a manufacturer of a part employed in a product may realize a batch of parts (e.g., parts 1-N) is defective. The manufacturer of the parts may provide a list of the defective parts (e.g., a subset of all parts) to a manufacturer of a product, which includes the parts, and to whom the defective parts were sold. In response, the manufacturer of the product may load such information into one or more ID tag scanner/readers 200, and employ the scanner/readers 200 to issue commands to parts 1004 throughout the product manufacturing environment. The command may instruct the ID tag 100 coupled to a part 1004 to provide a first signal (e.g., to turn red) if the ID tag 100 describes a part 1004 included in the defective part list. Otherwise, the ID tag 100 may remain its original color. Alternatively, in some embodiments, the command may instruct the ID tag 100 coupled to the part 1004 to provide a second signal (e.g., to turn green) if the ID tag 100 does not identify/describe a part 1004 included in the defective part list. In either case, the color (e.g., red) of the ID tags 100 coupled to respective defective parts 1004 may easily distinguish such parts from non-defective parts 1004, whose respective ID tags 100 are green or remain their original color.

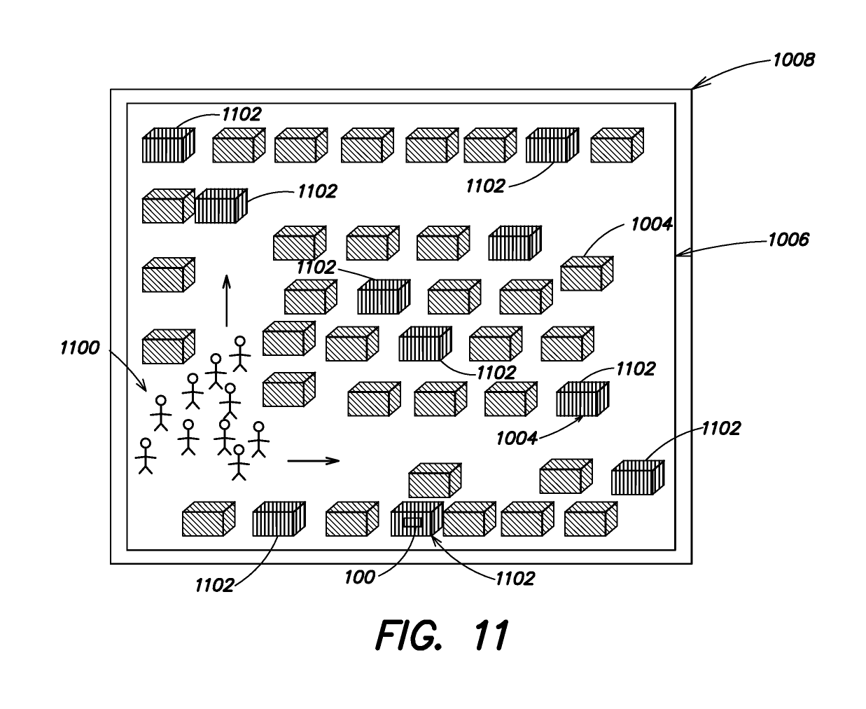

FIG. 11 illustrates a step in the method of FIG. 9 in which parts 1004 in a subset are contained in accordance with an embodiment of the present invention. With reference to FIG. 11, one or more people (e.g., laborers) 1100 may be dispatched to the warehouse 1006 to contain the subset of the parts 1004 (e.g., defective parts 1102). Because the perceptible signals (e.g., red color) provided by the ID tags 100 coupled to parts 1004 in the subset are easily observable, the laborers 1100 may walk around the warehouse 1006 and quickly identify (without using equipment) and pickup parts 1004 in the subset (e.g., defective parts). Although only the ID tag 100 changes color (e.g., to red), for convenience, in FIG. 11, the entire part 1004 to which the ID tag 100 is coupled is shown in the changed color (e.g., different cross-hatching). In this manner, parts 1102 included in the subset may be quickly contained. For example, a reduced amount of equipment 200 and/or personnel 1000, 1100 may be employed to contain the parts 1102. In this manner, a cycle time to contain such parts 1102 may be reduced.

Thereafter, step 910 may be performed. In step 910, the method 902 ends. Through use of the present method 900, parts 1102 included in a subset of all parts 1102 (e.g., defective parts) may be efficiently identified. More specifically, the improved ID tags 100 enable the subset of parts 1102 to be identified using a reduced amount of equipment 200 and/or personnel 1000, 1100.

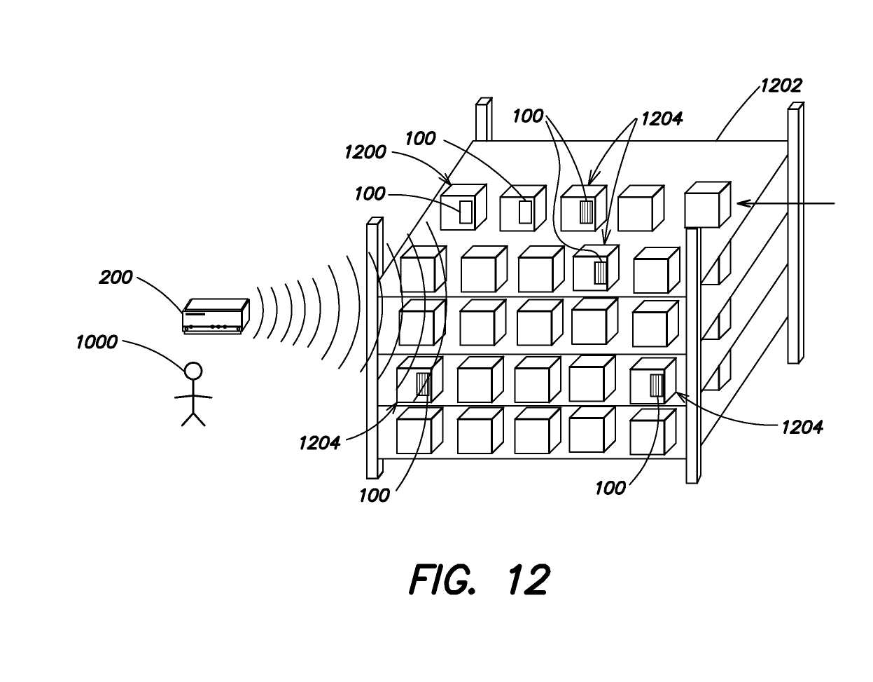

Although the method 900 is employed above to identify defective products in a warehouse 1006, the method 900 may be employed for a different purpose. FIG. 12 illustrates the method 900 of FIG. 9 performed on a plurality of parts 1200 stored in a flow rack 1202 in accordance with an embodiment of the present invention. With reference to FIG. 12, in a manner similar to that described above, the manufacturer of a product may obtain information from a parts manufacturer related to parts 1204 in a subset (e.g., defective parts) of all parts 1200, and load this information into one or more ID tag scanner/readers 200. For example, a user 1000 may employ the ID tag scanner/reader 200 to set a state of one or more ID tags 100 in the flow rack 1202 at nearly the same time from a distance (e.g., sweep set). For example, the user 1000 may walk by the flow rack 1202 to set ID tags 100 coupled to all defective parts 1204 to a first state, for example, which may cause the ID tag 100 to turn red. Because the signals (e.g., red color) provided by the ID tags 100 coupled to parts 1204 in the subset are easily observable, one or more people may visually identify defective parts and easily remove such parts 1204 from the flow rack 1202. As one part 1200 is removed from the flow rack 1202, another part 1200 behind such part 1200 may take its place. In this manner, a user may remove parts (including non-defective parts) from the flow rack 1202 such that all defective parts 1204 may be accessed and removed from the flow rack 1202. In this manner, parts 1204 included in the subset of all parts 1200 may be quickly contained. For example, a reduced amount of equipment 200 and/or personnel 1000 may be employed to contain the parts 1204.

Thus, the present methods and apparatus may provide enhanced ID tags 100 having respective persistent (e.g., unpowered) human-readable indicators or flags (e.g., a quality level indicator) integrated therewith. Such indicators may enable visual, audible or similar identification of parts that are non-conforming, suspect quality and/or include defective material in large and/or complex environments. By integrating indicators or flags with an ID tag, the present methods and apparatus may identify a subset of parts (e.g., defective parts) from a plurality of parts (e.g., all parts) without requiring handling of each part and/or software to analyze the part. For example, as described above, once an ID tag 100 indicator is set, a user may read such indicator without using an ID tag scanner/reader 200 to power the ID tag 100. Therefore, the present methods and apparatus may reduce a time and/or resources required for inventory sorts/screens and/or containment which provides significant benefits to supply chain activities such as manufacturing and distribution. For example, with a limited number of ID tag scanner/readers 200, persistent human readable quality level indicators on the enhanced tags in a large area or warehouse may be sweep set. Sorters further down the supply chain, may then identify the suspect goods without the use of RFID readers/scanners individually (e.g., to power to the improved RFID tag). For example, equipment (e.g., ID tag scanner/readers 200) required to provide inventory quality assurance/quality control may be reduced. Further, by reducing part and/or product handling, a chance of introducing additional defects due to such handling may be reduced.

The foregoing description discloses only exemplary embodiments of the invention. Modifications of the above disclosed apparatus and methods which fall within the scope of the invention will be readily apparent to those of ordinary skill in the art. For instance, although the improved ID tags 100 are employed above to provide a signal to identify defective parts in a subset of all parts of a product, the improved ID tags 100 may be employed in a similar manner to identify other objects from a large group of objects. For example, the improved ID tags 100 may be employed to identify expired smart cards in a group of smart cards. Alternatively, the indicator of the improved ID tag 100 may be employed to indicate whether a part to which the ID tag 100 is coupled has completed a critical point in a process. Such part may be considered unusable if the indicator is not set.

The improved ID tag 100 of the present invention may be adapted to provide the persistent human readable signal using a voltage that is within the operating range of the tag. Consequently, additional circuitry may not be required to boost voltage signals applied to the improved ID tag 100. In some embodiments, the ID tag scanner/reader 200 may transmit power of about 1 W, ID tag 100 may consume about 30 to about 50 microwatts, the controller 110 may consume 50 milliwatts and the material 112 may require about 0.02 to about 0.05 V to change state. However, the ID tag scanner/reader 200 may transmit a larger or smaller power, ID tag 100 may consume a larger or smaller amount of power, the controller 110 may consume a larger or smaller amount of power and/or the material may require a larger or smaller voltage to change state. Further, although two color changes are described above, the improved ID tag 100 may be adapted to change a plurality of colors by applying voltage to corresponding pins. Consequently, such ID tag 100 may include more than two pins 206, 208. The multiple colors may indicate multiple states, respectively.

Accordingly, while the present invention has been disclosed in connection with exemplary embodiments thereof, it should be understood that other embodiments may fall within the spirit and scope of the invention, as defined by the following claims.

The invention claimed is:

1. An identification device (ID) tag, comprising:
a semiconductor chip;
an antenna coupled to the semiconductor chip;
a layer of material, coupled to the semiconductor chip, and adapted to provide a persistent visual or audible signal that is observable by a human being; and
a controller coupled to the layer of material and adapted to cause the material to provide the signal.

2. The ID tag of claim 1 wherein the material is an electrochromic polymer.

3. The ID tag of claim 1 further comprising an adhesive backing adapted to couple the ID tag to a product part.

4. The ID tag of claim 1 wherein the controller is further adapted to cause the material to provide the signal in response to a command from an ID tag scanner/reader.

5. The ID tag of claim 4 wherein the antenna is adapted to receive the command via radio wave, shortwave, high frequency, ultra high frequency, microwave, wireless fidelity, or any other communication protocol.

6. The ID tag of claim 5 wherein the antenna is further adapted to receive the command from a single ID scanner/reader at approximately the same time as one or more antennas of other ID tags, respectively, without requiring either ID tag to be handled.

7. The ID tag of claim 1 wherein:
the material is further adapted to change to a first state in response to a first applied voltage; and
the controller is further adapted to apply the first voltage to the material to set the material to the first state.

8. The ID tag of claim 7 wherein:
the material is further adapted to change to another state in response to a different applied voltage; and
the controller is further adapted to apply the different voltage to the material to set the material to the other state.

9. The ID tag of claim 1 wherein the semiconductor chip is adapted to store a bit of data corresponding to the signal provided by the material.

10. A product manufacturing environment, comprising:
a plurality of parts for one or more products;
identification device (ID) tags coupled to the plurality of parts, respectively;
wherein each ID tag includes:
a semiconductor chip;
an antenna coupled to the semiconductor chip;
a layer of material, coupled to the semiconductor chip, and adapted to provide a persistent visual or audible signal that is observable by a human being; and
a controller coupled to the layer of material and adapted to cause the material to provide the signal.

11. The product manufacturing environment of claim 10 wherein the material of the ID tag is an electrochromic polymer.

12. The product manufacturing environment of claim 10 wherein the ID tag further comprises an adhesive backing adapted to couple the ID tag to one or more of the plurality of product parts.

13. The product manufacturing environment of claim 10 wherein the controller of the ID tag is further adapted to cause the material to provide the signal in response to a command from an ID tag scanner/reader.

14. The product manufacturing environment of claim 13 wherein the antenna of the ID tag is adapted to receive the command via radio wave, shortwave, high frequency, ultra high frequency, microwave, wireless fidelity, or any other communication protocol.

15. The product manufacturing environment of claim 14 wherein the antenna is further adapted to receive the command from the ID tag scanner/reader at approximately the same time as one or more antennas of other ID tags, respectively, without requiring the ID tags to be handled.

16. The product manufacturing environment of claim 10 wherein at least one of:
the material is further adapted to change to a first state in response to a first applied voltage and the controller is further adapted to apply the first voltage to the material to set the material to the first state; and
the material is further adapted to change to another state in response to a different applied voltage and the controller is further adapted to apply the different voltage to the material to set the material to the other state.

17. The product manufacturing environment of claim 16 wherein the semiconductor chip is adapted to store a bit of data corresponding to the state of the material.

18. A method of identifying a subset of parts in a plurality of parts, comprising:
providing a plurality of parts;
coupling identification device (ID) tags to the plurality of parts, respectively, wherein each ID tag includes:
a semiconductor chip;
an antenna coupled to the semiconductor chip;
a layer of material, coupled to the semiconductor chip, and adapted to provide a persistent visual or audible signal that is observable by a human being; and
a controller coupled to the layer of material and adapted to cause the material to provide the signal; and
employing the ID tags to identify the subset of the plurality of parts.

19. The method of claim 18 wherein the subset of parts includes parts which to not meet a quality requirement.

20. The method of claim 18 wherein employing the ID tags to identify the subset of the plurality of parts includes:
setting material in each ID tag coupled to a part in the subset to a first state; and
employing one or more persons to gather the parts coupled to ID tags including material in the first state.

21. The method of claim 20 wherein setting the material in each ID tag coupled to a part in the subset to the first state includes employing the controller of each ID tag coupled to a part in the subset to set the material to the first state in response to a command from an ID tag scanner/reader.

22. The method of claim 21 wherein employing the controller of each ID tag coupled to a part in the subset to set the material to the first state in response to a command from an ID tag scanner/reader includes employing the controller of each ID tag coupled to a part in the subset to apply a voltage to the material in the ID tag such that the material is set to the first state.

23. The method of claim 21 further comprising employing the antenna of each ID tag coupled to a part in the subset to receive the command via radio wave, shortwave, high frequency, ultra high frequency, microwave, wireless fidelity, or any other communication protocol.

24. The method of claim 20 wherein setting material in each ID tag coupled to a part in the subset to a first state includes employing a single ID tag scanner/reader to transmit a command to a plurality of ID tags coupled to respective parts in the subset at approximately the same time to set material in such plurality of ID tags to the first state without requiring such plurality of ID tags to be handled.

25. The method of claim 18 further comprising employing the semiconductor chip of each ID tag to store a bit of data corresponding to the signal provided by the material in the ID tag.
